(19) United States
(12) Patent Application Publication
(10) Pub. No.: US 2015/0343549 A1
(43) Pub. Date: Dec. 3, 2015

(54) MULTIPLE ELECTRODE WELDING SYSTEM WITH REDUCED SPATTER

(71) Applicant: Lincoln Global, Inc., City of Industry, CA (US)

(72) Inventors: Judah Henry, Geneva, OH (US); Steven R. Peters, Huntsburg, OH (US)

(21) Appl. No.: 14/725,547

(22) Filed: May 29, 2015

Related U.S. Application Data
(60) Provisional application No. 62/005,387, filed on May 30, 2014.

(51) Int. Cl. B23K 9/09; B23K 9/095

(52) U.S. Cl. CPC B23K 9/093; B23K 9/0953

(57) ABSTRACT

A system and method of electric arc welding that includes a welding apparatus having a plurality of welding machines, e.g., tandem welding, and a synchronizing controller. The synchronizing controller controls the phase relationship of the welding waveforms associated with the welding machines. Portions of the welding waveforms can be modified to include a short-clearing routine that minimizes spatter. The synchronizing controller modifies portions of the welding waveforms such that the short-clearing intervals begin at different times to avoid interference between the signals associated with short-clearing.

### CROSS REFERENCE TO RELATED APPLICATION

This application claims priority to, and any other benefit of, U.S. Provisional Patent Application Ser. No. 62/005,387, filed on May 30, 2014 and entitled Multiple Electrode Welding System with Reduced Spatter (Attorney Docket No. 22976/04123).

### BACKGROUND OF THE INVENTION

In electric arc welding, a popular welding process is pulse welding, which primarily uses a solid wire electrode with an outer shielding gas. Gas metal arc welding (GMAW), including, for example, metal inert gas (MIG) welding, uses spaced pulses to first melt the end of an advancing wire electrode and then propels the molten metal from the end of the wire through the arc to the workpiece. A globular mass of molten metal is transferred during each pulse period of the pulse welding process. During certain pulse periods, especially in applications where the welding electrode operates very close to the workpiece, molten metal contacts the workpiece before being entirely released from the advancing wire electrode. This creates a short circuit (a.k.a., a short) between the advancing wire electrode and the workpiece. It is desirable to eliminate or clear the short rapidly to obtain the consistency associated with proper pulse welding. Concurrent or tandem welding with multiple electrodes present difficulties because with multiple arcs, one arc can adversely affect the other arc. For example, during concurrent welding, the high heat and magnetic field from the arc of one welder will often adversely affect the arc and weld puddle from another welder or the common weld puddle, including attempts to clear a short.

In view of the foregoing problems and shortcomings of existing welding apparatus, the present application describes a system and method to overcome these shortcomings.

The following patents include information related to the subject matter of the current application and are also incorporated by reference herein in full: U.S. Ser. No. 07/739,900 (U.S. Pat. No. 5,155,330), filed Aug. 2, 1991; U.S. Ser. No. 09/200,594 (U.S. Pat. No. 6,051,810)), filed Nov. 27, 1998; U.S. Ser. No. 09/376,401 (U.S. Pat. No. 6,172,333 US), filed Aug. 18, 1999; U.S. Ser. No. 09/336,804 (U.S. Pat. No. 6,207,929), filed Jun. 21, 1999; U.S. Ser. No. 10/834,141 (U.S. Pat. No. 7,166,817), filed Apr. 29, 2004; U.S. Ser. No. 12/775,919 (U.S. Pat. No. 8,242,410), filed May 7, 2010; and U.S. Ser. No. 13/267,153 (Pat. Pub. No. 2012/0097655), filed Oct. 6, 2011.

### SUMMARY

According to one aspect of the present invention, a method of electric arc welding includes providing a welding apparatus having a plurality of welding machines and a synchronizing controller, wherein the synchronizing controller controls a phase relationship of a plurality of welding waveforms associated with the plurality of welding machines, modifying a portion of a first welding waveform associated with a first welding machine to reduce a first welding current during a first shorting interval of the first welding waveform, modifying a portion of a second welding waveform associated with a second welding machine to reduce a second welding current during a second shorting interval of the second welding waveform, and controlling the phase relationship of the welding waveforms such that the first shorting interval and the second shorting interval begin at different times.

The descriptions of the invention do not limit the words used in the claims in any way or the scope of the claims or invention. The words used in the claims have all of their full ordinary meanings

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention.

FIG. 1 is a simplified system diagram showing an exemplary welding system with synchronized welding machines according to one or more aspects of the present invention;

FIG. 2 illustrates a block diagram of an exemplary embodiment of an electric arc welding system with synchronized welding machines incorporating switching modules in the welding current paths;

FIG. 3 illustrates a diagram of an exemplary embodiment of portions of the system of FIG. 2, including the switching modules in the welding current paths;

FIG. 4 illustrates a flowchart of an exemplary embodiment of a method for reducing spatter in a pulsed electric arc welding process with synchronized welding machines using the system of FIGS. 2-3;

FIG. 5 illustrates an exemplary embodiment of pulsed output current waveforms resulting from the system of FIGS. 2-3 in accordance with the method of FIG. 4;

FIG. 6 illustrates a flowchart of another exemplary embodiment of a method for reducing spatter in a pulsed electric arc welding process with synchronized welding machines using the system of FIGS. 2-3;

FIG. 7 illustrates an exemplary embodiment of pulsed output current waveforms resulting from the system of FIGS. 2-3 in accordance with the method of FIG. 6; and

FIGS. 8A-8C depict multiple electrode welding embodiments with synchronized waveforms.

### DETAILED DESCRIPTION

The following includes definitions of exemplary terms used throughout the disclosure. Both singular and plural forms of all terms fall within each meaning:

“Logic,” synonymous with “circuit” as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device and/or controller. Logic may also be fully embodied as software.

“Software”, as used herein, includes but is not limited to one or more computer readable and/or executable instructions that cause a computer, logic, or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

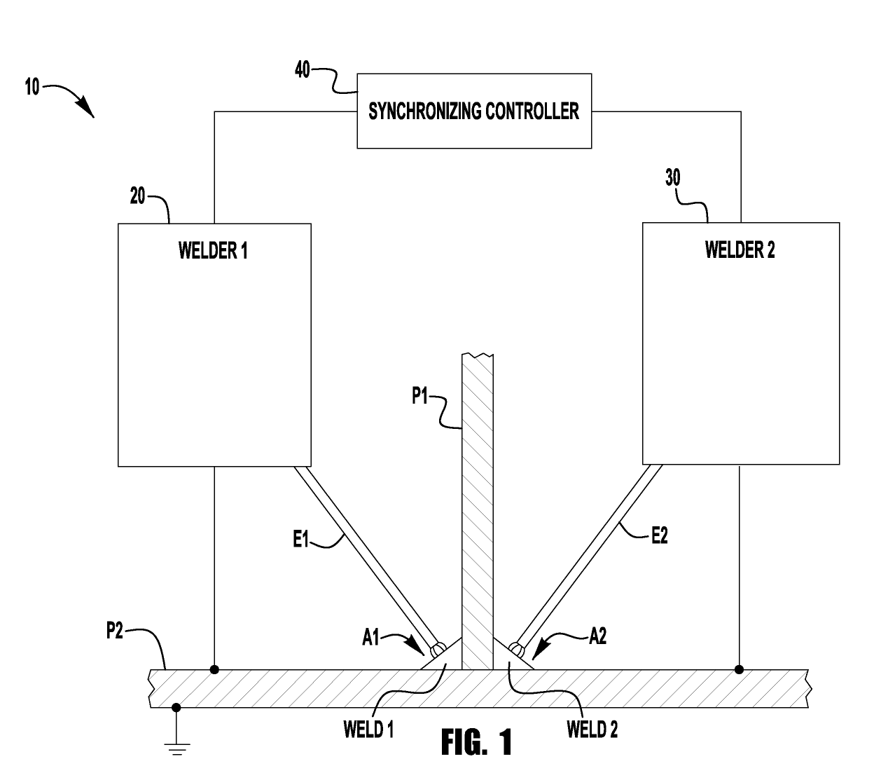

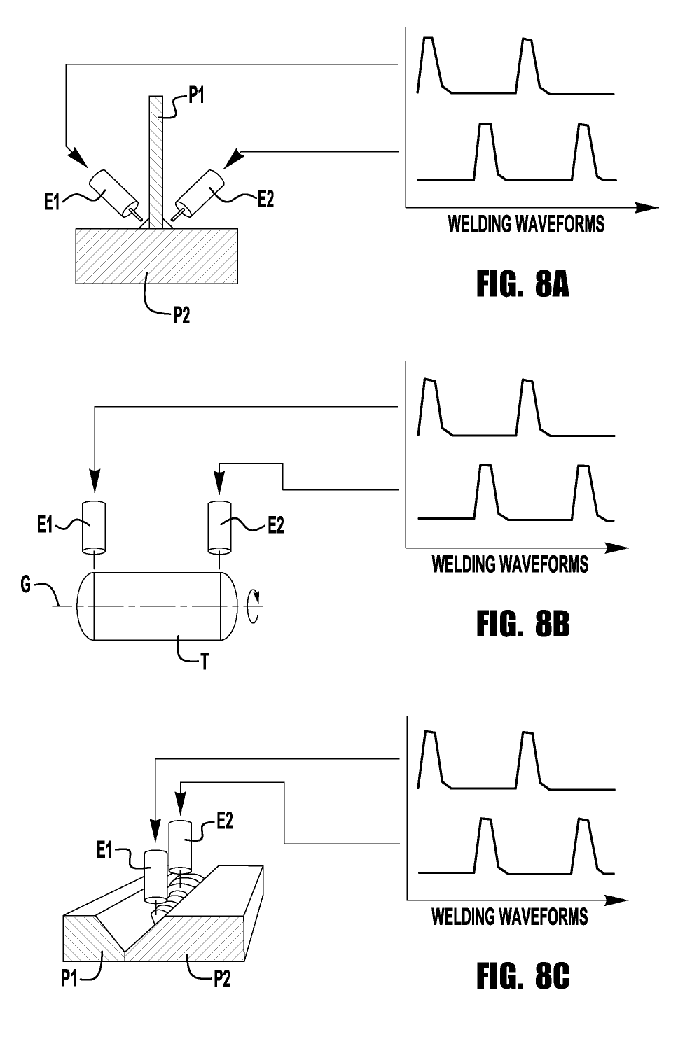

Although an exemplary embodiment is illustrated and described hereinafter in the context of root pass dual fillet welding using two welding electrodes positioned on opposite sides of a welded work piece (see, e.g., FIG. 1), other embodiments are possible in which two or more welding electrodes are used in creating a weld with one or more passes (see, e.g., FIGS. 8A-8C), with the waveforms applied to the electrodes and/or the work points used by opposing welding machines of a given pair being operated in a synchronized manner to provide controlled waveform and/or work point phase angles during concurrent welding. Further embodiments are also contemplated in which several passes can be used to form a weld, with the welding signal waveforms and/or work point waveforms being temporally synchronized such that the signals used in forming the welds are provided at a controllable phase relationship to one another. Other embodiments or implementations of the present invention include forming welds with multiple electrodes in a common puddle or simultaneously welding multiple points when there is a common ground axis.

An example of a multiple electrode implementation of the present invention is providing first and second electrodes forming a butt weld where a first electrode lays a first pass of weld material with the second electrode closely behind the first electrode laying a second pass of weld material on top of the first pass (see, e.g., FIG. 8C). The welding system of the present invention synchronizes the welding signal waveforms and/or work point waveforms to prevent the electrodes from interfering with each other when operating in the same weld puddle and can synchronize a spatter reducing short-clearing routine. This allows the electrodes to be placed in closer proximity to each other and reduces spatter. To reduce spatter associated with both electrodes, the welding system can synchronize welding signal waveforms, work point waveforms, and/or the short-clearing/spatter reducing system such that the signals used to form the welds are provided at staggered times or a controllable phase relationship to each other. In essence, the welding system can control a phase relationship by allowing one electrode to be clearing a short while the other electrode is not, such that the arcs from the electrodes do not interfere with each other, allowing spatter reducing routines to act on each electrode while welding on the same workpiece. In this regard, the specific embodiments illustrated and described hereinafter are not intended as limitations, but rather as examples of one or more possible preferred implementations of the various aspects of the invention

Referring now to the drawings, which are for purposes of illustrating embodiments of the invention only and not for purposes of limiting the same, FIG. 1 shows an exemplary dual welding apparatus 10, including first and second welding machines 20, 30 with a synchronizing controller 40 providing for control of the timing and phase relationship of either or both of the welding current waveforms and/or one or more machine work points in creating dual fillet welds 1 and 2 using electrodes E1 and E2 and welding arcs A1 and A2, respectively to weld a first work piece P1 to a second work piece P2. The synchronizing controller 40 may be provided in a welding system controller for performing a DC pulse dual fillet or other welding process using flux cored welding electrodes E1 and E2, an AC submerged arc welding (SAW) process using solid welding electrodes E1 and E2 or other suitable dual welding process using solid or cored electrodes with or without external shielding gas. The welding process is performed to create the first and second welds 1 and 2, respectively, on work piece P1, and in this embodiment a flat surface of the second work piece P2. The welding machines 20, 30 in the exemplary system 10 are generally similar to one another, although different machines may be used in other implementations.

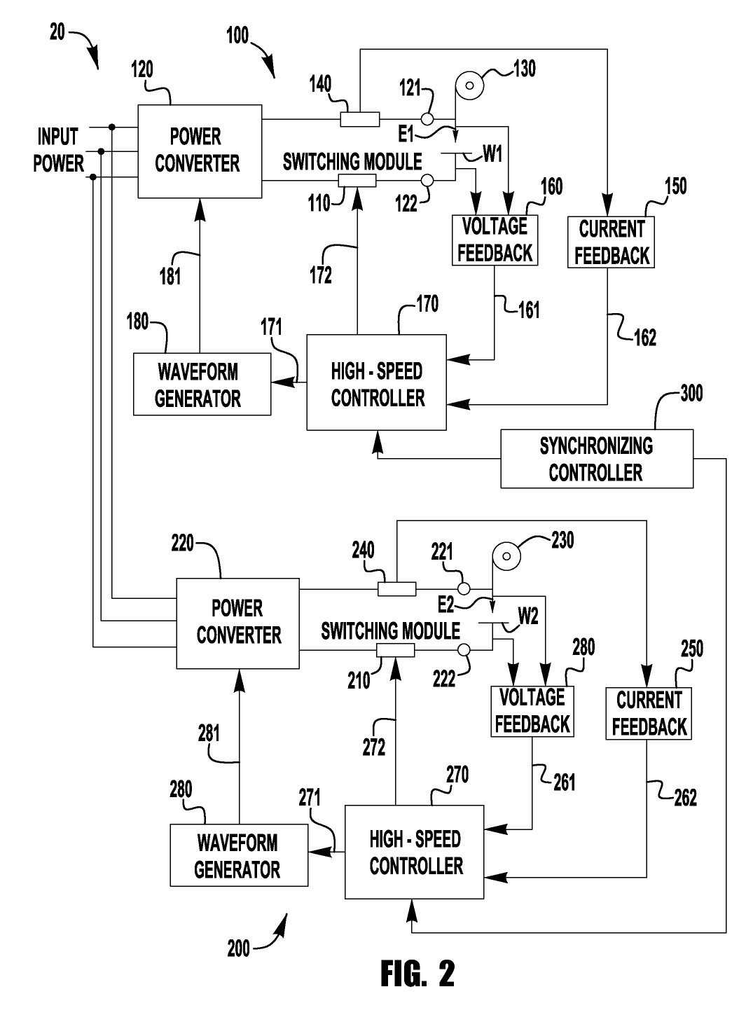

FIG. 2 illustrates a block diagram of an exemplary embodiment of an electric arc welding system 20 with exemplary welding systems 100, 200 and exemplary synchronizing controller 300. Welding systems 100, 200 each incorporate a respective current-modifying module or switching module 110, 210 in a welding output return path and provide welding outputs 121, 221 and welding outputs 122, 222. The current-modifying module or switching module 110, 210 can be used to modify or affect the current flowing through the welding circuit path, for example, by increasing and/or decreasing the resistance of the current path. The systems 100, 200 each include a power converter 120, 220 capable of converting an input power to a welding output power. The power converter 120, 220 may be an inverter-type power converter or a chopper-type power converter, for example. The systems 100, 200 further include a wire feeder 130, 230 capable of feeding a welding electrode wire E1, E2 through, for example, a welding gun (not shown) that connects the welding electrode wire E1, E2 to the welding output 121, 221.

The systems 100, 200 also include a current shunt 140, 240 operatively connected between the power converter 120, 220 and the welding output 121, 221 for feeding welding output current to a current feedback sensor 150, 250 of the system 100, 200 to sense the welding output current produced by the power converter 120, 220. The systems 100, 200 further include a voltage feedback sensor 160, 260 operatively connected between the welding output 121, 221 and the welding output 122, 222 for sensing the welding output voltage produced by the power converter 120, 220. As an alternative, the switching module 110, 210 could be incorporated in the outgoing welding current path, for example, between the power converter 120, 220 and the current shunt 140, 240, or between the current shunt 140, 240 and the welding output 121, 221.

The systems 100, 200 also include a high-speed controller 170, 270 operatively connected to the current feedback sensor 150, 250 and the voltage feedback sensor 160, 260 to receive sensed current and voltage in the form of signals 161, 261 and 162, 262 being representative of the welding output. The systems 100, 200 further include a waveform generator 180, 280 operatively connected to the high speed controller 170, 270 to receive command signals 171, 271 from the high speed controller 170, 270 that tell the waveform generator how to adapt the welding waveform signal 181, 281 in real time. The waveform generator 180, 280 produces an output welding waveform signal 181, 281 and the power converter 120, 220 is operatively connected to the waveform generator 180, 280 to receive the output welding waveform signal 181, 281. The power converter 120, 220 generates a modulated welding output (e.g., voltage and current) by converting an input power to a welding output power based on the output welding waveform signal 181, 281.

The switching module 110, 210 is operatively connected between the power converter 120, 220 and the welding output 122, 222, which is connected to the welding workpiece W1, W2 during operation, where in some embodiments W1 and W2 may be the same workpiece. The high speed controller 170, 270 is also operatively connected to the switching module 110, 210 to provide a switching command signal (or a blanking signal) 172, 272 to the switching module 110, 210. The high speed controller 170, 270 may include logic circuitry, a programmable microprocessor, and computer memory, in accordance with an embodiment of the present invention. As discussed in more detail below, in another embodiment, the switching module 110, 210 can be disabled or eliminated, allowing current to freely flow in the welding output circuit path. The controller 170, 270 or synchronizing controller 300 can be configured to command the waveform generator 180, 280 to modify a portion of the output welding waveform signal 181, 281 of the welding process during a shorting or blanking interval to modify, for example, reduce, the welding output current through the welding circuit path.

In accordance with an embodiment of the present invention, the high-speed controller 170, 270 may use the sensed voltage signal 161, 261, the sensed current signal 162, 262, or a combination of the two to determine when a short occurs between the advancing electrode E1, E2 and the workpiece W1, W2, when a short is about to clear, and/or when the short has actually cleared, during each pulse period. Such schemes of determining when a short occurs and when the short clears are well known in the art, and are described, for example, in U.S. Pat. No. 7,304,269, which is incorporated in full herein by reference. The high-speed controller 170, 270 may command the waveform generator 180, 280 to modify the waveform signal 181, 281 when the short occurs and/or when the short is cleared. For example, when a short is determined to have been cleared, the high-speed controller 170, 270 may command the waveform generator 180, 280 to incorporate a plasma boost pulse in the waveform signal 181, 281 to prevent another short from occurring immediately after the clearing of the previous short.

In the example of FIG. 2, the systems 100, 200 are operatively coupled with a synchronizing controller 300 of a system controller for exchanging data and control signals, messages, data, etc. therewith. The system controller may also include other controllers and systems, such as, for example, a travel controller and/or a work piece allocation system. Such systems and controllers are known in the art, and are described, for example, in U.S. Pat. No. 8,242,410, which is incorporated in full herein by reference. In another embodiment, controllers 170, 270 and 300 are combined in one system controller. In yet another embodiment, controller 170 may function as a master controller, incorporating the functions of the synchronizing controller, while controller 270 acts as a slave controller, receiving synchronizing signals from controller 170.

In one embodiment, the synchronizing controller 300 is operatively coupled with the controllers 170, 270 and provides synchronization information (e.g., signals, messages, etc.) to synchronize the first and second waveform generators 180, 280 such that the first and second welding currents are at a controlled phase angle with respect to one another. The wire feeders 130, 230 may also be synchronized by or according to suitable information (data, signaling, etc.) from synchronizing controller 300 and/or directly from the respective controllers 170, 270 or other intermediate components in order to coordinate the provision of welding wire to the dual welding process according to the current welding waveforms and other process conditions at a particular point in time. Similarly, the shielding gas supplies (not shown) may be controlled in synchronized fashion using the control apparatus of the systems 100, 200 according to synchronization information from the synchronizing controller 300. Moreover, the allocation system or the synchronizing controller 300 or other system components may provide for modulation of one or more machine work points according to work point waveforms to provide a controlled machine work point phase angle between the work point waveforms. In other embodiments, one or both of the synchronizing controller 300 and the work point allocation system may be separately housed, or may be integrated in one or more system components, such as the systems 100, 200 or components thereof, for example. Control of the system 20 may be via one system controller that includes the synchronizing controller 300 and/or the controllers 170, 270. I.e., the controllers may be separate and/or distributed or one controller may perform the functions of the synchronizing controller 300, controllers 170, 270, and/or other controllers and various combinations thereof.

Generally, in various embodiments, waveforms, welding currents, shorting intervals, blanking intervals, etc. may be out of phase or staggered in any manner that avoids interference of the signals. For example, in one embodiment, the signals may be out of phase by about a phase angle, where the phase angle is 360 degrees divided by the number of the welding machines. In other embodiments, the beginning of signal features (e.g., the shorting intervals) may be staggered a predefined time such that the signal features begin at different times and/or do not overlap.

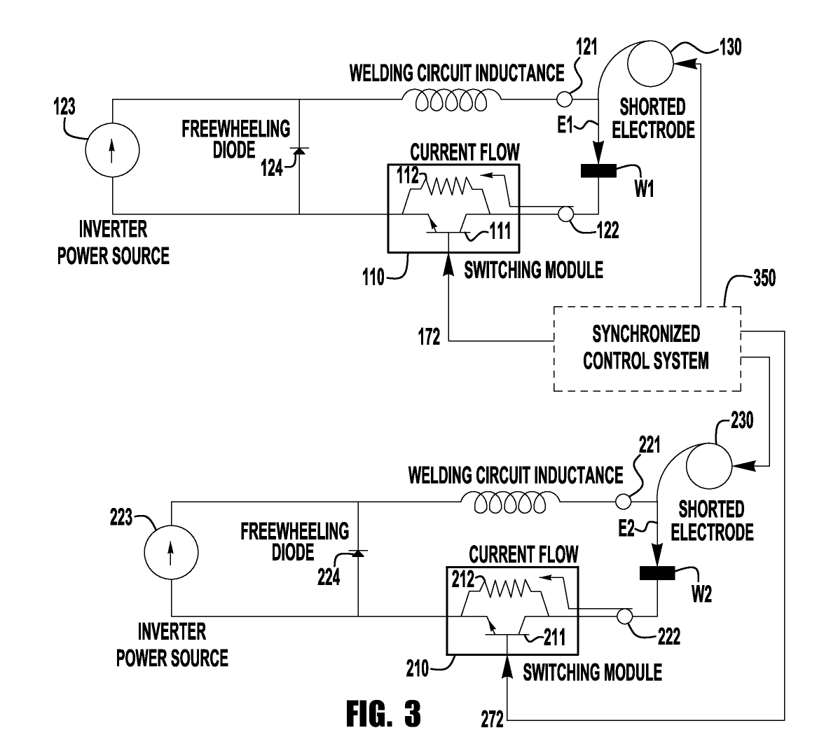

FIG. 3 illustrates a diagram of an exemplary embodiment of a portion of the system 20, and in particular, portions of systems 100, 200 of FIG. 2, including the switching module 110, 210 in the welding current return paths. The synchronized control system 350 may be any arrangement or combination of a synchronizing controller (e.g., synchronizing controller 300), welder controllers (e.g., controllers 170, 270), and/or other controllers as described above. The power converters 120, 220 may each include an inverter power source 123, 223 and a freewheeling diode 124, 224. The welding output path will have an inherent welding circuit inductance due to the various electrical components within the welding output path. The switching modules 110, 210 are shown as having an electrical switch 111, 211 (e.g., a power transistor circuit) in parallel with a resistive path 112, 212 (e.g., a network of high power rated resistors).

During a pulse period of the welding waveform of either system 100, 200, when no short is present, the electrical switch 111, 211 is commanded to be closed by the switching command signal 172, 272 from the controller system 350. When the electrical switch 111, 211 is closed, the electrical switch 111, 211 provides a very low resistance path in the output welding return path, allowing welding current to freely return to the power converter 120, 220 through the switch 111, 211. The resistive path 112, 212 is still present in the welding output return path, but most of the current will flow through the low resistance path provided by the closed switch 111, 211. However, when a short is detected in either system 100, 200, the associated electrical switch 111, 211 is commanded to be opened by the respective switching command signal 172, 272 from the controller system 350. When the electrical switch 111, 211 is opened, current is cut off from flowing through the switch 111, 211 and is forced to flow through the resistive path 112, 212, resulting in the level of the current being reduced due to the resistance provided by the resistive path 112, 212.

Because the controller system 350 is controlling the timing of the waveforms associated with the systems 100, 200 to be out of phase, the potential for shorts and switching command signals 172, 272 are also out of phase with each other.

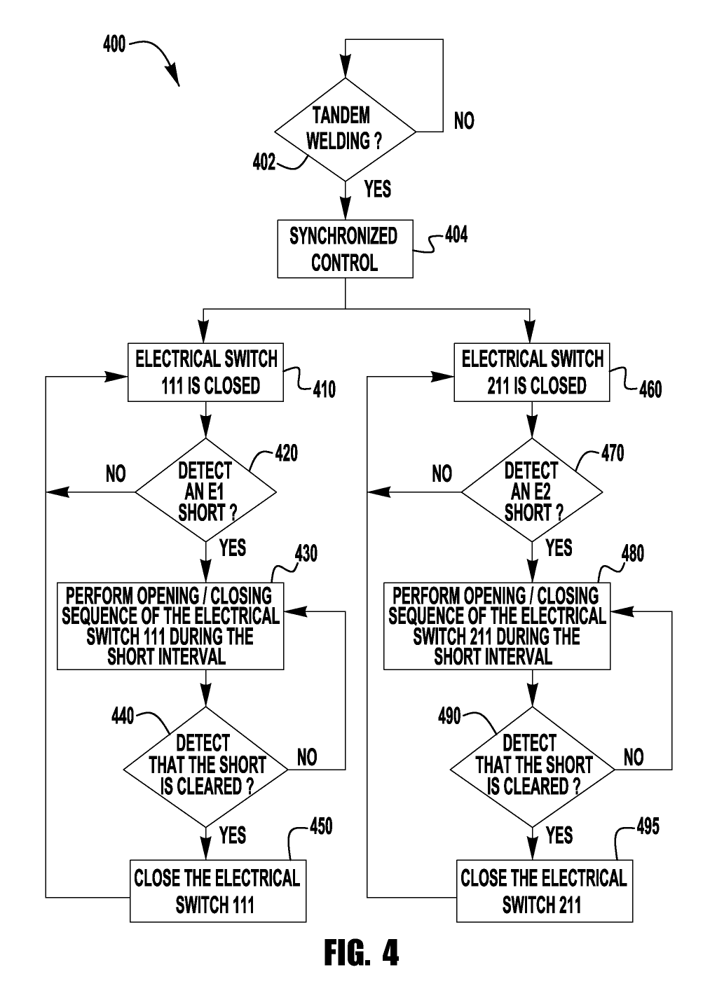

FIG. 4 illustrates a flowchart of an exemplary embodiment of a method 400 for reducing spatter in a pulsed electric arc welding system with synchronized welding machines using the system 20 of FIGS. 2-3. At step 402, tandem (multiple electrode) welding may be utilized. Step 404 specifies synchronized control of systems 100, 200. Step 410 represents operation where the switch 111 of the switching module 110 is normally closed (no short condition). In step 420, if a short is not detected, then the switch 111 remains closed (no short condition). However, if a short is detected at E1, then in step 430, the switch 111 is commanded to go through an opening and closing sequence during the short interval (i.e., the time period over which the electrode E1 is shorted to the workpiece W1).

The opening/closing sequence in step 430 starts by opening the switch 111 when the short is first detected. The switch 111 remains open for a first period of time (e.g., a first 10% of the short interval). This decreases the output current quickly so the short does not break right away causing a large amount of spatter. After the first period of time, the switch 111 is again closed and the output current is ramped during a second period of time to cause the molten short to begin to form a narrow neck in an attempt to break free from the electrode E1 and clear the short. During this second period of time, as the current is ramping, a dv/dt detection scheme is performed to anticipate when the short will clear (i.e., when the neck will break). Such a dv/dt scheme is well known in the art. The switch 111 is then opened again just before the short is about to clear (e.g., during the last 10% of the short interval) in order to quickly lower the output current once again to prevent excessive spattering when the neck actually breaks (i.e., when the short actually clears).

In step 440, if the short (short between the electrode E1 and the workpiece W1) is still present, then the switch 111 remains open. However, if the short has been cleared then, in step 450, the switch 111 is again closed. In this manner, during a short condition, the switch 111 goes through an opening/closing sequence and the current flowing through the welding output path is reduced when the switch 111 is open, resulting in reduced spatter. The method 400 is implemented in the high-speed controller 170, synchronized controller 300, or a system controller, as described above.

Similarly, steps 460, 470, 480, 490, and 495 are processed for clearing shorts for electrode E2 using switch 211 using the synchronized control system. Furthermore, in accordance with an embodiment of the present invention, the system 100, 200 is able to react at a rate of 120 kHz (i.e., the switching module 110, 210 can be switched on and off at this high rate), providing sufficient reaction to detection of a short and detection of the clearing of the short to implement the method 400 in an effective manner.

In accordance with a somewhat simpler alternative embodiment, instead of going through the opening/closing sequence described above with respect to FIG. 4, the current of the welding circuit path is decreased, in response to detection of a short between the advancing wire electrode and the workpiece, by opening the respective switch 111, 211 for at least a determined period of time, thus increasing the resistance in the welding circuit path. For most pulse periods, the determined period of time is of a duration allowing for the short to clear without having to first increase the current of the welding circuit path. During a given pulse period, if the short clears before the determined period of time has expired as desired, then the process proceeds to the next part of the pulse period. However, if the short does not clear within the predetermined period of time then, immediately after the determined period of time, the respective switch 111, 211 is closed again, causing the current of the welding circuit path to once again increase and clear the short. In such an alternative embodiment, the respective switch 111, 211 is simply opened for at least part of the determined period of time in response to the detection of the short. In most pulse periods, the current does not have to be increased to clear the short.

Furthermore as an option, when the short between the advancing wire electrode and the workpiece is detected, a speed of the advancing wire electrode can be slowed. Slowing the speed of the advancing wire electrode helps to clear the short more readily by not adding as much material to the short as otherwise would be added. To slow the speed of the advancing wire electrode, a motor of a wire feeder advancing the wire electrode may be switched off and a brake may be applied to the motor. The brake may be a mechanical brake or an electrical brake, in accordance with various embodiments.

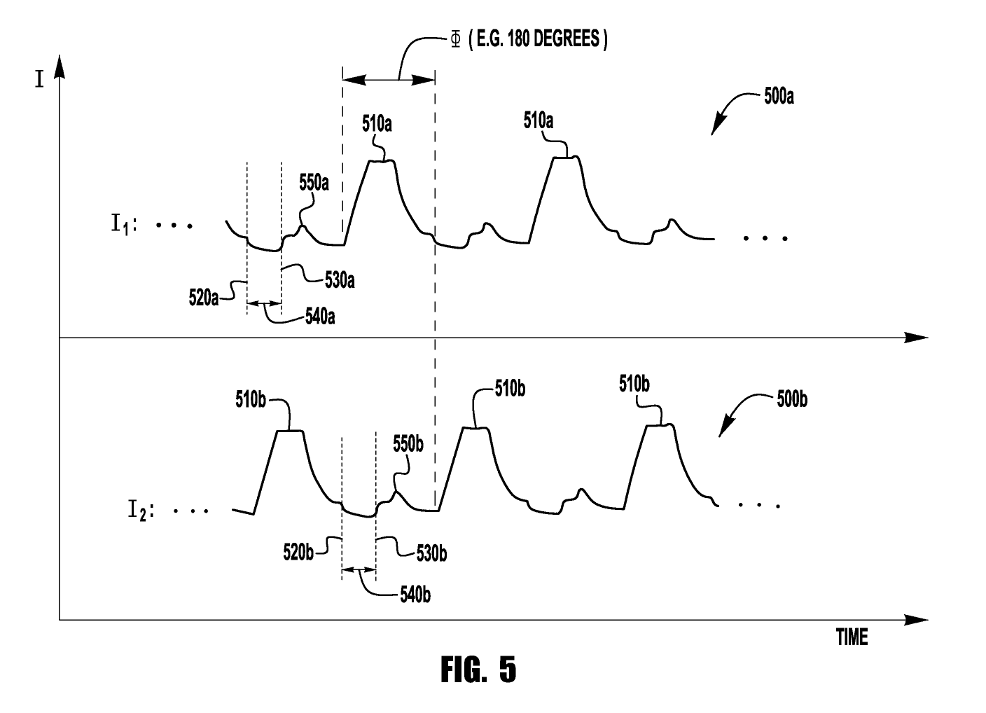

FIG. 5 illustrates an exemplary embodiment of pulsed output current waveforms 500a, 500b resulting from the respective pulsed electric arc welding systems 100, 200 of FIG. 2 that use the switching modules 110, 210 of FIGS. 2-3 in accordance with the method 400 of FIG. 4. The waveforms 500a and 500b are synchronized to be out of phase by an angle φ, as described in more detail below. As can be seen from the waveforms 500a, 500b of FIG. 5, after a peak pulse 510a, 510b is fired, a short may occur starting at time 520a, 520b for example, that lasts until time 530a, 530b, for example, when the short is cleared. The times 520a, 520b and 530a, 530b define a short interval 540a, 540b. As can be seen in FIG. 5, peak pulses 510a, 510b are fired at regular intervals during the multiple pulse periods or cycles of the welding process. During any given cycle, a short condition may or may not occur. However, when the distance between the tip of the electrode and the workpiece is relatively small, a short can occur on almost every cycle.

Referring again to FIG. 5, during the short interval 540a, 540b, the respective switch 111, 211 of the switching module 110, 210 is opened when the short first occurs and again when the short is about to clear, causing the output current to flow through the resistive path 112, 212, causing the current level to reduce. As an example, the switching signal 172, 272 may be a logic signal that goes from high to low when a short is detected, causing the switch to open. Similarly, when the short is cleared, the switching signal 172, 272 may go from low to high to close the switch 111, 211 again. When the switch 111, 211 is opened, the resistive path 112, 212 puts a load on the welding output path allowing the freewheeling current to drop quickly to desired levels. The current tends to reduce until the short is cleared and, at such reduced current levels, when the short breaks or clears, the molten metal tends to pinch off in an unexplosive manner, eliminating or at least reducing the amount of spatter created. Also, in the waveforms 500a, 500b of FIG. 5, the plasma boost pulse 550a, 550b, which is used to help prevent another short from occurring immediately after the short that was just cleared, is more prominent and potentially more effective.

Now focusing on the synchronized control shown in FIG. 5 (with further reference to FIG. 2), the systems 100, 200 are provided with synchronization information, such as heartbeat signals, messages, etc., from the synchronizing controller 300, with the waveform generators 180, 280 operating to create the first and second welding currents 11 and 12 at the controllable waveform phase angle φ. In this fashion, with the waveform phase angle φ at about zero (not shown), the pulse current levels of the first and second currents 11 and 12 would be substantially aligned in time.

FIG. 5 illustrates a controlled and synchronized non-zero degree waveform phase angle φ, (e.g., about 180 degree waveform phase angle φ). In this embodiment, the magnetic effects of the two pulse welding arcs will be substantially out-of-phase for waveform phase angles φ of about 180 degrees, such as 175 to 185 degrees, thereby allowing control over short clearing in addition to weld uniformity, penetration, shape, size, etc. through the controlled waveform synchronization in system 20. In other embodiments, other waveform phase angles φ may also be suitable to allow for short clearing to reduce spatter without interference from other out of phase welders. In this manner, the short intervals 540a, 540b and associated short clearing steps shown in FIG. 4 are out of phase with each other, providing reduced spatter with multiple welders.

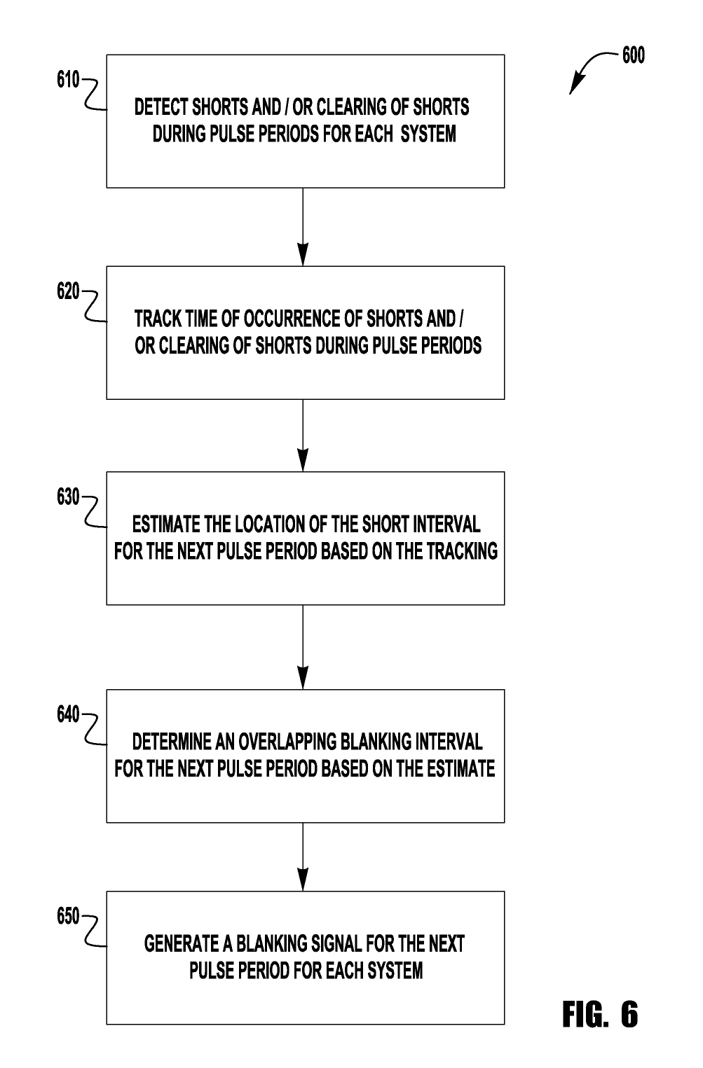

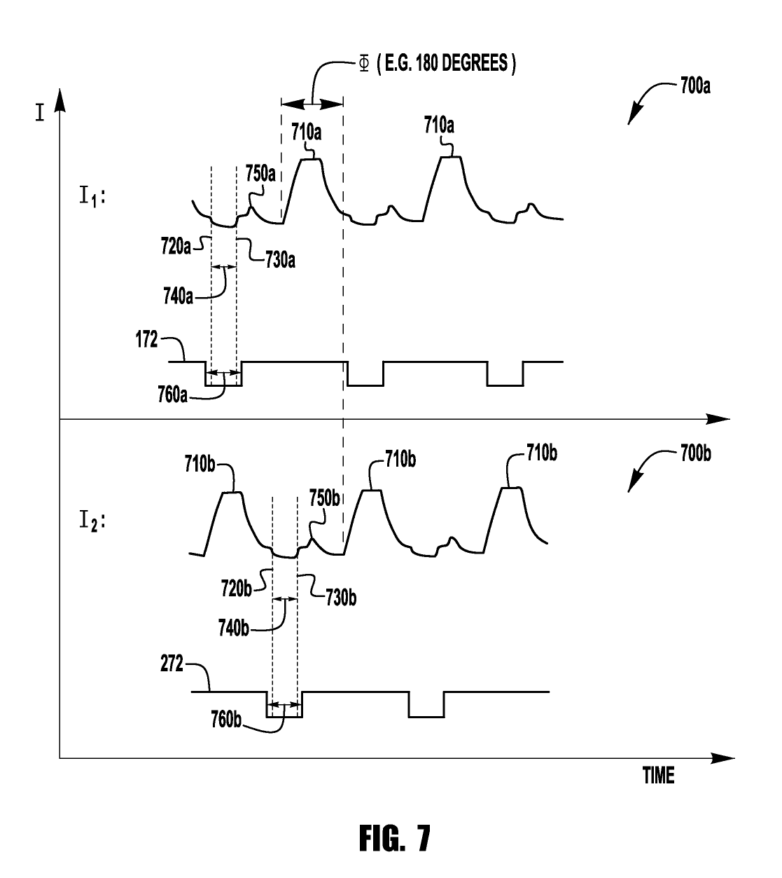

FIG. 6 illustrates a flowchart of another example embodiment of a method 600 for reducing spatter in a pulsed electric arc welding system with synchronized welding machines using the system of FIGS. 2-3. With additional reference to FIG. 7, a controller (e.g., controllers, 170, 270 or 300) tracks the times of occurrence of the shorts and/or the clearing of the shorts and provides an estimate of when the short interval 740a, 740b (the time between the occurrence of a short and when the short is cleared) will occur during at least the next pulse period. From this estimate, a blanking interval 760a, 760b can be determined which is used to generate the blanking signal 172, 272.

In step 610 of the method 600, the system 20 detects the occurrence of shorts and/or the clearing of those shorts during the repeating pulse periods of the pulsed welding waveforms 700a, 700b for each system 100, 200, according to known techniques. In step 620, the time of occurrence of the detected shorts and/or clearings within the pulse periods are tracked (e.g., by the high-speed controller 170, 270 or synchronizing controller 300). In step 630, the location and duration of the short interval 740a, 740b for a next pulse period is estimated based on the tracking results. In step 640, an overlapping blanking interval 760a, 760b for at least the next pulse period is determined based on the estimated location of the short interval for the next pulse period. In step 650, a blanking signal (a type of switching signal) 172, 272 is generated (e.g., by the controller 170, 270 or synchronizing controller 300) to be applied to the switching module 110, 210 during the next pulse period.

FIG. 7 illustrates an example of pulsed output current waveforms 700a, 700b resulting from the pulsed electric arc welding systems 100, 200 of FIGS. 2-3 that use the switching modules 110, 210 of FIGS. 2-3 in accordance with the method 600 of FIG. 6. As can be seen from the waveforms 700a, 700b of FIG. 7, after a peak pulse 710a, 710b is fired, a short may occur starting at time 720a, 720b, for example, that lasts until time 730a, 730b, for example, when the short is cleared. The times 720a, 720b and 730a, 730b define a short interval 740a, 740b. As can be seen in FIG. 7, peak pulses 710a, 710b are fired at regular intervals during the welding process. During any given cycle, a short condition may or may not occur. However, during a welding process where the arc length is relatively short (i.e., where the wire electrode is operated relatively close to the workpiece), shorts can occur in almost every pulse period.

In accordance with the method 600, the times of occurrence of the short and/or clearing of the short within the pulse period are determined and tracked from pulse period to pulse period. In this manner, the controller 170, 270 or synchronizing controller 300 may estimate the location of the short interval that will likely occur in the next or upcoming pulse periods. However, at the beginning of a pulsed welding process, before any substantial tracking information is available, the location of the short interval may be a stored default location based on, for example, experimental data or stored data from a previous welding process. The blanking signal 172, 272 can be adapted or modified to form a blanking interval 760a, 760b within the blanking signal 172, 272, which temporally overlaps the estimated short interval 740a, 740b for the next pulse period(s). Ideally, the blanking interval 760a, 760b starts shortly before the short interval 740a, 740b of the next pulse period (e.g., before the time 720a, 720b) and ends shortly after the short interval 740a, 740b of the next pulse period (e.g., after the time 730a, 730b), thus the temporal overlap. In one embodiment, only the times of occurrence of a short are tracked, not the clearing of the shorts. In such an embodiment, the duration of the blanking interval is set to last long enough for the short to clear, based on experimental knowledge.

In this manner, the actual occurrence of a short during the next pulse period does not have to be detected before the switch 111, 211 of the switching module 110, 210 can be opened. As the pulsed welding process progresses, the location of the short interval may drift or change as the distance between the wire electrode and the workpiece drifts or changes, for example. However, in this embodiment, since the location of the short interval is being tracked over time, the location of the blanking signal can be adapted to effectively follow and anticipate the short interval. By opening the switch 111, 211 during the blanking interval 760a, 760b, the current drops and it is expected that the tether will occur and break during the blanking interval 760a, 760b.

Now focusing on the synchronized control shown in FIG. 7 (with further reference to FIG. 2), the systems 100, 200 are provided with synchronization information, such as heartbeat signals, messages, etc., from the synchronizing controller 300, with the waveform generators 180, 280 operating to create the first and second welding currents 11 and 12 at the controllable waveform phase angle φ. FIG. 7 illustrates a controlled and synchronized non-zero degree waveform phase angle φ, (e.g., about 180 degree waveform phase angle φ). In this embodiment, the magnetic effects of the two pulse welding arcs will be substantially out-of-phase for waveform phase angles φ of about 180 degrees, such as 175 to 185 degrees, thereby allowing control over short clearing in addition to weld uniformity, penetration, shape, size, etc. through the controlled waveform synchronization in system 20. In other embodiments, other waveform phase angles φ may also be suitable to allow for short clearing to reduce spatter without interference from other out of phase welders. In this manner, the short intervals 740a, 740b and associated short clearing steps and blanking signals 172, 272 shown in FIG. 6 are out of phase with each other, providing reduced spatter with multiple welders.

Experimental results have shown that, using the synchronized control over switching modules 110, 210 as described herein in a particular tandem pulsed welding scenario, the welding output current levels at the point of clearing the short can be reduced from about 280 amps to about 40 amps, making a tremendous difference in the amount of spatter produced. In general, reducing the current below 50 amps seems to significantly reduce spatter. In addition, travel speeds (e.g., 60-80 inches/minute) and deposition rates are able to be maintained.

Other synchronized means and methods of reducing the welding output current level during the time period when a short is present between a welding electrode and a workpiece in a tandem system are possible as well. For example, in an alternative embodiment, the control topology of a welding power source may be configured to control the output current to a highly regulated level during the time of the short. The power source can control the shorting current to a lower level (e.g., below 50 amps) during a shorting interval to reduce the spatter when out of phase with the other power source. For example, referring to FIG. 2, the switching module 110, 210 can be disabled or eliminated, allowing current to freely flow in the welding output circuit path. The controller 170, 270 or synchronizing controller 300 is configured to command the waveform generator 180, 280 to modify a portion of the output welding waveform signal 181, 281 of the welding process during the blanking interval to reduce the welding output current through the welding output circuit path. Therefore, in this alternative embodiment, the controller 170, 270 or synchronizing controller 300 reduces the current during the blanking interval through the waveform generator 180, 280 and the power converter 120, 220 instead of via the switching module 110, 210. Such an alternative embodiment can work quite well if the inductance of the welding circuit is sufficiently low.

Although the embodiment shown in FIG. 1 is a “T” joint with fillet welds, the present invention is applicable to many other applications. For example, FIGS. 8A-8C depict alternative embodiments of the present invention in which two or more electrodes E1, E2 are used to deposit material in applications where interference between the electrodes E1, E2 is expected. For example, similar to FIG. 1, FIG. 8A depicts a dual fillet weld with opposing electrodes E1, E2. As illustrated schematically, in accordance with the concepts of the present invention, waveform synchronization may be used to apply the described short clearing process and the waveforms shown in the accompanying chart out of phase with each other (e.g., phase angles φ of about 180 degrees) to control the arc onto the electrodes E1, E2 such that they do not interfere with each other. The same synchronization may also be used in an application where the electrodes E1, E2 share a common ground axis, such as, for example, a tank T welding application depicted in FIG. 8B. There, while the electrodes E1, E2 operate on separate welds, their shared ground axis G is likely to create interference between the electrodes E1, E2 affecting the ability to clear shorts and the quality of the weld. As depicted in the accompanying chart, waveform synchronization techniques described above may be used to minimize and/or eliminate the interference between the electrodes E1, E2 and allow for the described short clearing process. Another application where this type of interference is seen is when both electrodes E1, E2 operate on the same weld puddle or pool. For example, as depicted in FIG. 8C, two electrodes E1, E2 may operate in the same weld puddle when applying layers of electrode material to a butt joint in a successive fashion where a first electrode E1 lays a base layer of material and second electrode E2 follows close behind with a second layer of material above the base layer. Because these electrodes E1, E2 operate in the same puddle, it is common for there to be interference between the electrodes E1, E2. As depicted in the accompanying chart in FIG. 8C, the waveform synchronization techniques described above may be used to minimize and/or eliminate this interference to allow for the described short clearing process, resulting in more uniform and consistent welds in this type of application. For example, as described above, the waveforms may be generated such that the first and second arcs are placed 180 degrees out of phase with respect to each other.

While the embodiments discussed herein have been related to the systems and methods discussed above, these embodiments are intended to be exemplary and are not intended to limit the applicability of these embodiments to only those discussions set forth herein. The control systems and methodologies discussed herein may be equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those of skill in the art.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

We claim:

1. A method of electric arc welding, comprising:
providing a welding apparatus having a plurality of welding machines and a synchronizing controller, wherein the synchronizing controller controls a phase relationship of a plurality of welding waveforms associated with the plurality of welding machines;
modifying a portion of a first welding waveform associated with a first welding machine to reduce a first welding current during a first shorting interval of the first welding waveform;
modifying a portion of a second welding waveform associated with a second welding machine to reduce a second welding current during a second shorting interval of the second welding waveform; and
controlling the phase relationship of the welding waveforms such that the first shorting interval and the second shorting interval begin at different times.

2. The method of claim 1, wherein modifying a portion of one of the plurality of welding waveforms to reduce a welding current during a shorting interval of the welding waveform comprises:
detecting a short condition in a weld associated with the one of the plurality of welding machines; and
increasing an electrical resistance of a welding current path associated with the weld in response to the short condition.

3. The method of claim 2, wherein modifying a portion of one of the plurality of welding waveforms to reduce a welding current during a shorting interval of the welding waveform further comprises:
detecting that the short condition is cleared; and
decreasing the electrical resistance of the welding current path.

4. The method of claim 2, wherein modifying a portion of one of the plurality of welding waveforms to reduce a welding current during a shorting interval of the welding waveform comprises:
increasing the electrical resistance for a first time period to prevent the short condition from breaking;
decreasing the electrical resistance for a second time period to prepare to clear the short condition;
increasing the electrical resistance for a third period of time in anticipation of clearing the short condition.

5. The method of claim 4, wherein modifying a portion of one of the plurality of welding waveforms to reduce a welding current during a shorting interval of the welding waveform further comprises:
detecting that the short condition is cleared; and
decreasing the electrical resistance of the welding current path;
wherein the electrical resistance is repeatedly increased and decreased until the short condition is cleared.

6. The method of claim 1, wherein the welding waveforms are about 180 degrees out of phase.

7. The method of claim 1, further comprising:
modifying a portion of each of the plurality of welding waveforms associated with the plurality of welding machines to reduce a plurality of welding currents during a plurality of shorting intervals of the plurality of welding waveforms;
controlling the phase relationship of the welding waveforms such that none of the shorting intervals overlap.

8. The method of claim 7, wherein the plurality of welding waveforms are out of phase by about a phase angle, wherein the phase angle is 360 degrees divided by the number of the welding machines.

9. The method of claim 1, further comprising:
tracking times of occurrences of short conditions in a first weld associated with the first welding machine;
tracking times of occurrences of short conditions in a second weld associated with the second welding machine;
estimating the time for the first shorting interval and the time for the second shorting interval based on the tracking;
determining a first blanking interval associated with the first shorting interval;
determining a second blanking interval associated with the second shorting interval;
modifying a portion of the first welding waveform associated with the first welding machine to reduce the first welding current during the first blanking interval, wherein the first blanking interval temporally overlaps the estimated time of the first shorting interval;
modifying a portion of the second welding waveform associated with the second welding machine to reduce the second welding current during the second blanking interval, wherein the second blanking interval temporally overlaps the estimated time of the second shorting interval; and
controlling the phase relationship of the welding waveforms such that the first blanking interval and the second blanking do not overlap.

10. A welding system, comprising:
a plurality of welding machines;
a synchronizing controller, wherein the synchronizing controller controls a phase relationship of a plurality of welding waveforms associated with the plurality of welding machines, and wherein the synchronizing controller comprises:
logic for modifying a portion of a first welding waveform associated with a first welding machine to reduce a first welding current during a first shorting interval of the first welding waveform;
logic for modifying a portion of a second welding waveform associated with a second welding machine to reduce a second welding current during a second shorting interval of the second welding waveform; and
logic for controlling the phase relationship of the welding waveforms such that the first shorting interval and the second shorting interval begin at different times.

11. The system of claim 10, wherein a controller of one of the plurality of welding machines comprises the synchronizing controller.

12. The system of claim 11, further comprising a system controller, wherein the system controller comprises the synchronizing controller.

13. The system of claim 10, further comprising a first switching module in a first welding current path associated with the first welding machine, wherein activation of the first switching module changes an electrical resistance of the first welding current path, and wherein the logic for modifying a portion of a first welding waveform associated with the first welding machine to reduce the first welding current during the first shorting interval of the first welding waveform activates the first switching module.

14. The system of claim 13, wherein the switching module comprises a switch in parallel with a first resistive path, and wherein activation of the switch provides a second resistive path.

15. The system of claim 14, wherein the first resistive path is greater than the second resistive path.

16. The system of claim 10, wherein the logic for modifying a portion of one of the plurality of welding waveforms to reduce a welding current during a shorting interval of the welding waveform comprises activating a switching module to increase an electrical resistance of a welding current path associated with a weld in response to detecting a short condition in the weld.

17. The system of claim 10, further comprising:
logic for tracking times of occurrences of short conditions in a first weld associated with the first welding machine;
logic for tracking times of occurrences of short conditions in a second weld associated with the second welding machine;
logic for estimating the time for the first shorting interval and the time for the second shorting interval based on the tracking;
logic for determining a first blanking interval associated with the first shorting interval;
logic for determining a second blanking interval associated with the second shorting interval;
logic for modifying a portion of the first welding waveform associated with the first welding machine to reduce the first welding current during the first blanking interval, wherein the first blanking interval temporally overlaps the estimated time of the first shorting interval;
logic for modifying a portion of the second welding waveform associated with the second welding machine to reduce the second welding current during the second blanking interval, wherein the second blanking interval temporally overlaps the estimated time of the second shorting interval; and
logic for controlling the phase relationship of the welding waveforms such that the first blanking interval and the second blanking do not overlap.

18. The system of claim 10, wherein the plurality of welding machines comprises two welding machines and the plurality of welding waveforms are about 180 degrees out of phase.

19. The system of claim 10, wherein the plurality of welding machines comprises three welding machines and the plurality of welding waveforms are about 120 degrees out of phase.

20. A welding system, comprising:
a means for welding comprising a plurality of welding machines;
a means for modifying a portion of a first welding waveform associated with a first welding machine to reduce a first welding current during a first shorting interval of the first welding waveform;
a means for modifying a portion of a second welding waveform associated with a second welding machine to reduce a second welding current during a second shorting interval of the second welding waveform; and
a means for controlling a phase relationship of welding waveforms associated with the plurality of welding machines such that the first shorting interval and the second shorting interval do not overlap.
